(19) United States
(12) Patent Application Publication
(10) Pub. No.: US 2026/0051782 A1
(43) Pub. Date: Feb. 19, 2026

(54) Brushless motor with segmented housing

(71) Applicant: Hunan Yichi Motor Co., Ltd., Yiyang (CN)

(72) Inventors: Tianyou Cao, Yiyang (CN); Changqing Gui, Shenzhen (CN)

(21) Appl. No.: 19/367,072

(22) Filed: Oct. 23, 2025

(30) Foreign Application Priority Data
May 22, 2025 (CN) 202521020266.2

(51) Int. Cl. H02K 5/04; H02K 5/24; H02K 7/08; H02K 9/06; H02K 11/33

(52) U.S. Cl. CPC H02K 5/04; H02K 5/24; H02K 7/083; H02K 9/06; H02K 11/33; H02K 2211/03

(57) ABSTRACT

Disclosed is a brushless motor with a segmented housing. The brushless motor with a segmented housing includes a first cylinder, a second cylinder, a stator and a rotor. The first cylinder and the second cylinder are fitted to each other. A stator fixture is arranged in each of the first cylinder and the second cylinder and the stator is fixedly installed on the stator fixtures. The rotor crosses the stator. A bearing installation groove is formed in each of the stator fixtures. Two ends of the rotor are each connected with a bearing and the bearings are respectively installed in the corresponding bearing installation grooves. One end of the rotor passes through the corresponding bearing installation groove and is fixedly connected to a blade wheel.

### BACKGROUND OF THE DISCLOSURE

### Technical Field

The present disclosure relates to the technical field of brushless motors and, in particular, to a brushless motor with a segmented housing.

### Description of Related Art

As we all know, a brushless direct-current (DC) motor, which is composed of a motor body and a driver, is a typical mechatronic product. Since brushless DC motors operate in a self-controlled manner, they will not need additional starting windings on rotors like synchronous motors that start heavy-duty under variable frequency speed regulation, nor will they produce oscillations or out-of-step when the load changes suddenly. Therefore, brushless motors are used in various electrical devices, especially in daily appliances such as hair dryers and vacuum cleaners.

For brushless motors used in hair dryers or vacuum cleaners, in structure, a blade wheel will be provided and deflectors will be provided in a housing to increase the wind pressure blown out by the blade wheel. However, the housing of a conventional brushless motor is configured as an integrated cylinder, and the deflectors are arranged between the cylinder and a stator bracket and are integrated with the cylinder. That is, the deflectors need to be formed integrally with the cylinder. As a result, the deflectors in upper and lower halves of the cylinder can only be made into one form, such as inclined, curved or vertical. However, in actual application, corresponding customized designs cannot be achieved according to different needs. For example, some need a vertical deflector in the lower half and an arc-shaped deflector in the upper half, some need a vertical deflector in the upper half and an arc-shaped deflector in the lower half, or some need a vertical deflector in the lower half and an inclined deflector in the upper half. Therefore, it is difficult to flexibly match the defectors in the assembly and production of conventional brushless motors.

### SUMMARY OF THE DISCLOSURE

In view of the above shortcomings in the prior art, an objective of the present disclosure is to provide a brushless motor with a segmented housing.

In order to achieve the above objective, the present disclosure adopts the following technical solutions:

A brushless motor with a segmented housing includes a first cylinder, a second cylinder, a stator and a rotor. The first cylinder and the second cylinder are fitted to each other. A stator fixture is arranged in each of the first cylinder and the second cylinder and the stator is fixedly installed on the stator fixtures. The rotor crosses the stator. A bearing installation groove is formed in each of the stator fixtures. Two ends of the rotor are each connected with a bearing and the bearings are respectively installed in the corresponding bearing installation grooves. One end of the rotor passes through the corresponding bearing installation groove and is fixedly connected to a blade wheel. A deflector is respectively arranged between the first cylinder and the corresponding stator fixture and between the second cylinder and the corresponding stator fixture.

Preferably, a pre-compressed spring is sleeved on a shaft rod of the rotor, one end of the spring abuts against a magnet of the rotor, and the other end of the spring abuts against the bearing at the same end.

Preferably, a connecting end opening is provided at one end opening of the first cylinder, one end opening of the second cylinder is provided with a connecting end socket insertable into the connecting end opening, and at least one glue storage groove is formed in an inner wall of the connecting end opening or an outer end face of the connecting end socket.

Preferably, positioning openings adapted to be aligned with each other are provided at the connecting end socket and at least the connecting end opening.

Preferably, the brushless motor with a segmented housing further includes a circuit board, coil windings of the stator are connected with conductive posts, and one ends of the conductive posts pass through the stator fixture and are placed outside and welded to solder pads of the circuit board.

Preferably, the stator fixtures are each provided with air guide holes, and the air guide holes are connected to the coil windings of the stator.

Preferably, a sheath is provided between the coil windings of the stator and the first cylinder and between the coil windings of the stator and the second cylinder, and the sheaths are made of an insulating material.

Based on the above solutions, according to the present disclosure, an originally integrated cylinder is divided into two: a first cylinder and a second cylinder, to form two assemblies. In this way, during production and manufacturing, the first cylinder or the second cylinder with different deflectors may be flexibly replaced as needed, so that the product is changed according to actual needs, thus achieving the technical effect of flexible use.

### BRIEF DESCRIPTION OF THE DRAWINGS

FIG. 1 is a schematic structural diagram of a brushless motor with a segmented housing in an embodiment of the present disclosure.

FIG. 2 is a schematic structural diagram of the brushless motor with a segmented housing in an embodiment of the present disclosure viewed from another direction.

FIG. 3 is a sectional view of the brushless motor with a segmented housing in an embodiment of the present disclosure.

FIG. 4 is a schematic structural diagram of the brushless motor with a segmented housing in an embodiment of the present disclosure after being separated.

### DETAILED DESCRIPTION OF THE INVENTION

In order to make the objective, technical solution and advantages of the present disclosure more clearly understood, the present disclosure is further described in detail in combination with the accompanying drawings and embodiments. It should be understood that the specific embodiments described herein are only intended to explain the present disclosure but not to define the present disclosure.

In the description of the present disclosure, it should be understood that the orientation or position relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, etc., are based on the orientation or position relationships shown in the accompanying drawings and are used only for the convenience of describing the present disclosure and simplifying the description, rather than indicating or implying that the device or element referred to must have a specific orientation, be constructed and operated in a specific orientation. Therefore, they should not be understood as limiting the present disclosure. In addition, the terms “first” and “second” are used for descriptive purposes only rather than being understood as indicating or implying relative importance or as implicitly indicating the quantity of technical features indicated. Therefore, the features defined as “first” and “second” may explicitly or implicitly include one or more of the features. As described herein, “a plurality of” means two or more, unless otherwise clearly and specifically defined.

In the description of the present disclosure, it should be noted that, unless otherwise expressly specified and limited, the terms such as “mounted”, “connected to” and “connect” shall be understood broadly. For example, they may refer to fixed connection, detachable connection, or integrated connection. They may refer to mechanical connection or electrical connection. They may refer to direct connection or indirect connection by means of an intermediate medium. They may refer to internal connection between two elements or an interactive relationship between two elements. For those of ordinary skill in the art, the specific meanings of the above terms in the present disclosure can be understood according to specific situations.

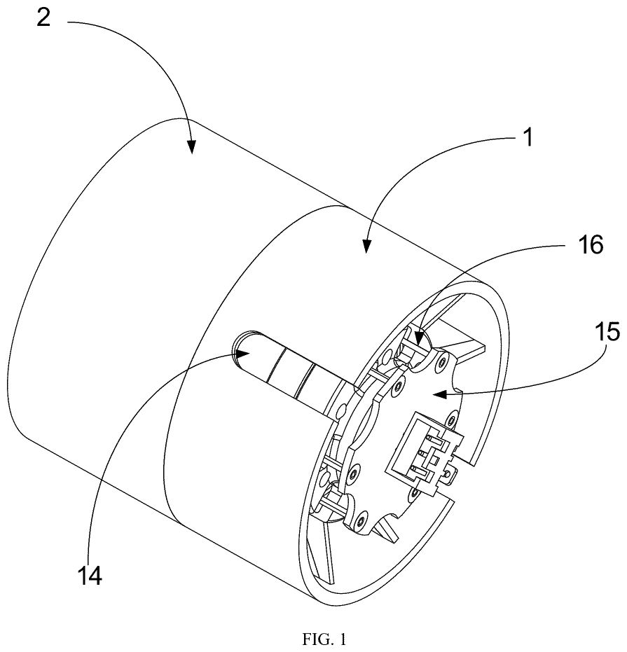

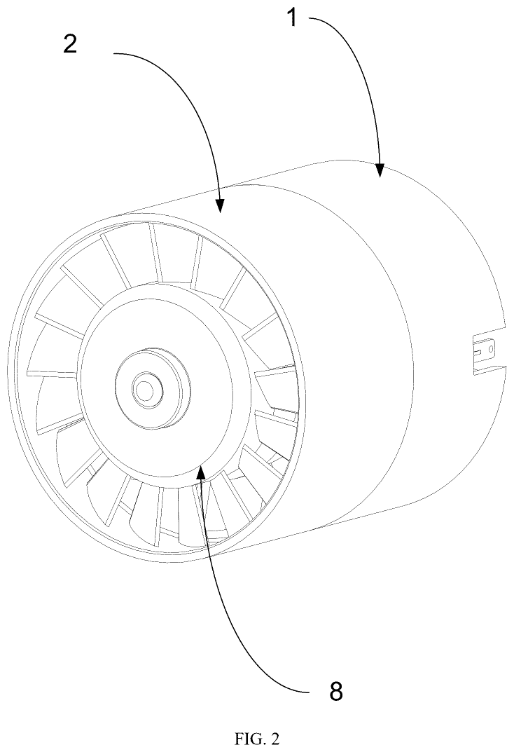

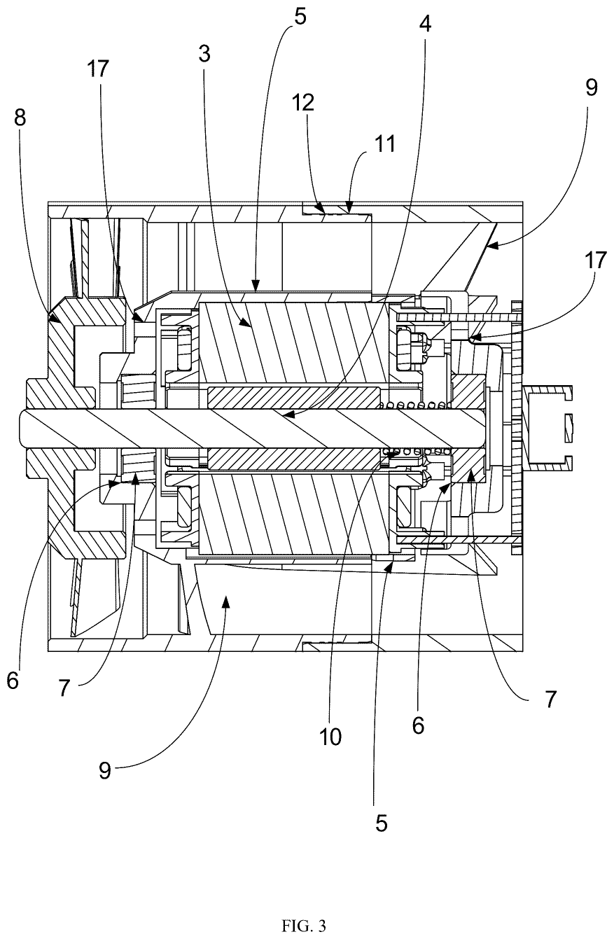

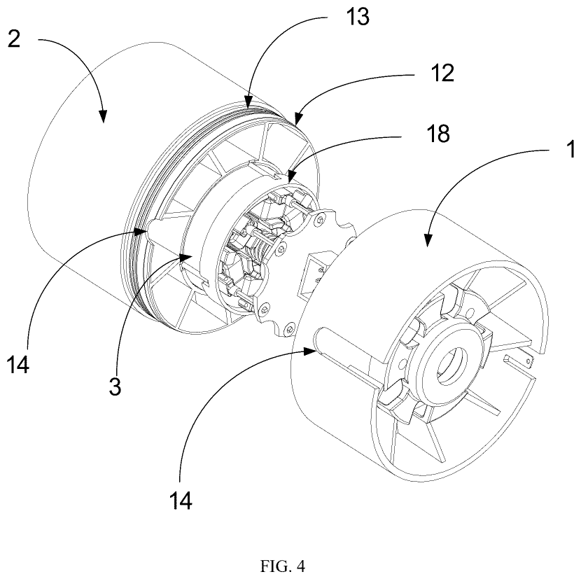

As shown in FIGS. 1-4, a brushless motor with a segmented housing in this embodiment includes a first cylinder 1, a second cylinder 2, a stator 3 and a rotor 4. The first cylinder 1 and the second cylinder 2 are fitted to each other. A stator fixture 5 is arranged in each of the first cylinder 1 and the second cylinder 2. The stator 3 is fixedly installed on the stator fixtures 5. The rotor 4 crosses the stator 3. A bearing installation groove 6 is formed in each of the stator fixtures 5. Two ends of the rotor 4 are each connected with a bearing 7 and the bearings 7 are respectively installed in the corresponding bearing installation grooves 6. One end of the rotor 4 passes through the corresponding bearing installation groove 6 and is fixedly connected to a blade wheel 8, and a deflector 9 is respectively arranged between the first cylinder 1 and the corresponding stator fixture 5 and between the second cylinder 2 and the corresponding stator fixture 5. In actual use, a plurality of first cylinders 1 and second cylinders 2 having different styles of deflectors 9 may be provided and then selectively assembled.

For this embodiment, it is mainly implemented as follows: an originally integrated cylinder is divided into two: a first cylinder 1 and a second cylinder 2, to form two assemblies. In this way, during production and manufacturing, the first cylinder 1 or the second cylinder 2 with different deflectors 9 may be flexibly replaced as needed, so that the product is changed according to actual needs, thus achieving the technical effect of flexible use.

Further, in order to make the bearing installed more firmly, in this embodiment, a pre-compressed spring 10 is sleeved on a shaft rod of the rotor 4, one end of the spring 10 abuts against a magnet of the rotor 4, and the other end of the spring 10 abuts against the bearing 7 at the same end. By using the pre-compressed spring 10, a pre-tightening force may be provided between the bearing 7 and the rotor 4 by the spring 10, so that the bearing 7 is installed more firmly. Once the bearing 7 is installed more firmly, the service life may be extended and noise may be reduced.

Further, for the fitting between the first cylinder 1 and the second cylinder 2, this embodiment may be implemented specifically as follows: a connecting end opening 11 is provided at one end opening of the first cylinder 1, one end opening of the second cylinder 2 is provided with a connecting end socket 12 insertable into the connecting end opening 11, and at least one glue storage groove 13 is formed in an inner wall of the connecting end opening 11 or an outer end face of the connecting end socket 12. By this design, the connecting end opening 11 and the connecting end socket 12 are first aligned with each other and then fixed with glue. In order to allow more glue to stay, the glue storage groove 13 is provided. The glue storage groove 13 allows more glue to stay at the alignment position. Moreover, the number of glue storage grooves 13 is determined according to actual situations, and typically 3 to 5 glue storage grooves are enough to meet the gluing needs.

Further, because the first cylinder 1 and the second cylinder 2 are configured as cylindrical structures, when the connecting end opening 11 and the connecting end socket 12 are assembled, position alignment should be ensured, otherwise the deflectors 9 of the first cylinder 1 and the second cylinder 2 cannot be aligned with each other, and if the deflectors 9 are staggered, wind resistance will be formed, which affects the air outlet efficiency. In view of the foregoing, in this embodiment, positioning openings 14 adapted to be aligned with each other are provided at the connecting end socket 12 and at least the connecting end opening 11. Due to the existence of the positioning openings 14, it may be confirmed that the first cylinder 1 and the second cylinder 2 are fitted in a correct orientation after the connecting end opening 11 and the connecting end socket 12 are assembled and the positioning openings 14 in the first cylinder 1 and the second cylinder 2 are aligned with each other.

Further, in this embodiment, the brushless motor further includes a circuit board 15. In order to increase the heat dissipation requirements for the circuit board 15 itself, in this embodiment, coil windings of the stator 3 are connected with conductive posts 16, and one ends of the conductive posts 16 pass through the stator fixture 5 and are placed outside and welded to solder pads of the circuit board 15.

Further, in order to dissipate heat from the coil windings of the stator 3, in this embodiment, the stator fixtures 5 are each provided with air guide holes 17, and the air guide holes 17 are connected to the coil windings of the stator 3. The air current generated by the blade wheel 8 dissipates heat from the coil windings of the stator 3. It should be noted that the bearing installation grooves 6 are all configured as semi-enclosed structures to stop wind from passing through the bearings 7, thereby reducing damage caused by wind to the bearings 7.

In addition, in operation, there is an influence of creepage distance at wire crossing points of the coil windings of the stator 3 after the stator 3 is electrified. In order to provide insulation protection, in this embodiment, a sheath 18 is provided between the coil windings of the stator 3 and the first cylinder 1 and between the coil windings of the stator 3 and the second cylinder 2, and the sheaths are made of an insulating material. The sheaths 18 are specifically provided at wire crossing bridges of the coil windings, and achieve the effect of blocking protection based on the insulation characteristics of the sheaths 18.

The above is only the preferred embodiment of the present disclosure, and does not therefore limit the scope of the patent of the present disclosure. All the equivalent structure or equivalent process transformations made by using the contents of the specification of the present disclosure and the accompanying drawings, or directly or indirectly applied in other related technical fields, are similarly included in the scope of patent of the present disclosure.

What is claimed is:

1. A brushless motor with a segmented housing, comprising a first cylinder, a second cylinder, a stator and a rotor, wherein the first cylinder and the second cylinder are fitted to each other; a stator fixture is arranged in each of the first cylinder and the second cylinder and the stator is fixedly installed on the stator fixtures; the rotor crosses the stator; a bearing installation groove is formed in each of the stator fixtures; two ends of the rotor are each connected with a bearing and the bearings are respectively installed in the corresponding bearing installation grooves; one end of the rotor passes through the corresponding bearing installation groove and is fixedly connected to a blade wheel; a deflector is respectively arranged between the first cylinder and the corresponding stator fixture and between the second cylinder and the corresponding stator fixture.

2. The brushless motor with a segmented housing according to claim 1, characterized in that: a pre-compressed spring is sleeved on a shaft rod of the rotor, one end of the spring abuts against a magnet of the rotor, and the other end of the spring abuts against the bearing at the same end.

3. The brushless motor with a segmented housing according to claim 1, characterized in that: a connecting end opening is provided at one end opening of the first cylinder, one end opening of the second cylinder is provided with a connecting end socket insertable into the connecting end opening, and at least one glue storage groove is formed in an inner wall of the connecting end opening or an outer end face of the connecting end socket.

4. The brushless motor with a segmented housing according to claim 3, characterized in that: positioning openings adapted to be aligned with each other are provided at the connecting end socket and at least the connecting end opening.

5. The brushless motor with a segmented housing according to claim 1, further comprising a circuit board, wherein coil windings of the stator are connected with conductive posts, and one ends of the conductive posts pass through the stator fixture and are placed outside and welded to solder pads of the circuit board.

6. The brushless motor with a segmented housing according to claim 1, characterized in that: the stator fixtures are each provided with air guide holes, and the air guide holes are connected to the coil windings of the stator.

7. The brushless motor with a segmented housing according to claim 1, characterized in that: a sheath is provided between the coil windings of the stator and the first cylinder and between the coil windings of the stator and the second cylinder, and the sheaths are made of an insulating material.
